(19) United States
(12) Patent Application Publication
(10) Pub. No.: US 2011/0062851 A1
(43) Pub. Date: Mar. 17, 2011

(54) Holding Rod

(75) Inventors: Rainer Koger, Berlin (DE); Klaus-Dieter Stein, Munchen (DE)

(73) Assignee: PATENT-TREUHAND-GESELLSCHAFT FUR ELEKTRISCHE GLUHLAMPEN MBH, MUNCHEN (DE)

(21) Appl. No.: 11/989,519

(22) PCT Filed: Jul. 25, 2006
(86) PCT No.: PCT/EP2006/007342

§ 371 Date: Jan. 28, 2008

(30) Foreign Application Priority Data
Jul. 27, 2005 (DE) 10 2005 035 190.5

(51) Int. Cl. H01K 1/18

(52) U.S. Cl. 313/292

(57) ABSTRACT

The invention discloses a holding rod 20, 22 for a discharge lamp 2, in particular a mercury vapor or xenon short-arc lamp, for holding an anode 24 or cathode 26 in an interior 6 of a discharge vessel 4, the holding rod 20, 22 containing doped molybdenum or tungsten doped with at least one metal oxide compound. Furthermore, the invention discloses a discharge lamp having such a holding rod 20, 22.

### TECHNICAL FIELD

The invention relates to a holding rod for holding an anode or cathode in accordance with patent claims 1 and 5 and to a discharge lamp having at least one such holding rod.

### PRIOR ART

Discharge lamps, in particular mercury vapor or xenon short-arc lamps, generally have two holding rods for holding their anode and cathode in a discharge chamber, said two holding rods consisting of tungsten doped with potassium. One disadvantage of this material composition is the fact that it is very brittle and thus, in the case of high-wattage discharge lamps, i.e. in particular in the case of lamps with a wattage greater than 2 kW, breakages occur again and again during transportation since such discharge lamps have very heavy anodes and long holding rod lengths. Mentioned by way of example is a conventional 5 kW mercury vapor short-art lamp which has an anode mass of approximately 1000 g and a holding rod length of approximately 100 mm.

One possibility for avoiding such breakages during transportation consists in increasing the size of the cross section of the holding rods such that the holding rods can accommodate the large anode masses. Owing to the compact design of the discharge lamps, however, such a geometric enlargement is only possible to a limited extent.

Another possibility for avoiding breakages during transportation is considered to be that of increasing the strength of the holding rods. A known measure is the use of thoriated tungsten in place of tungsten doped with potassium, which, however, has the disadvantage that the thorium used for this purpose is radioactive and therefore such a holding rod represents a radioactive load for the environment.

### DESCRIPTION OF THE INVENTION

The invention is based on the object of providing a holding rod for holding an anode or cathode of a discharge lamp, which has a high strength in order to avoid breakages and whose material composition does not represent a radioactive load for the environment. The invention is likewise based on the object of providing a discharge lamp having at least one such holding rod.

This object is achieved as regards the holding rod by the features of patent claims 1 and 5 and as regards the discharge lamp by the features of patent claim 9. Particularly advantageous embodiments of the invention are described in the dependent claims.

The holding rod according to the invention for a discharge lamp, in particular a mercury vapor or xenon short-arc lamp, for holding an anode or cathode in an interior of a discharge vessel contains molybdenum doped according to the invention.

An alternative solution according to the invention is provided by a holding rod, in the case of which the holding rod contains tungsten doped with at least one metal oxide compound. The metal oxide compound likewise results in an increase in the strength of the holding rod. Examples of metal oxide compounds are lanthanum oxide, yttrium oxide and rhenium oxide.

A discharge lamp according to the invention has at least one holding rod consisting of doped molybdenum or of tungsten which is doped with a metal oxide compound.

Doped molybdenum has the advantage that it has increased ductility compared with tungsten doped with potassium after a heat treatment or annealing during production of the discharge lamp and during operation of the discharge lamp. Owing to the ductility of the doped molybdenum, after the annealing process, as part of the production process, the strength up to the beginning of the plastic deformation (yield point) increases by approximately fourfold in comparison with tungsten doped with potassium. Furthermore, it is advantageous that molybdenum has a lower specific weight than tungsten, with the result that a corresponding discharge lamp can be designed to have a reduced weight.

Potassium is preferably used as the dopant, which has the advantage that molybdenum doped with potassium (MoQ) can be produced in a simple and cost-effective manner, and this material does not represent a radioactive load for the environment. For example, the volume content of the potassium is approximately 100 ppm to approximately 400 ppm, preferably approximately 280 ppm.

The ductility of the MoQ can be further increased if the holding rod is annealed prior to installation in a range above 1800° C., preferably at 2400° C. This recrystallization annealing leads to an MoQ with a low loss of strength, but the recrystallized structure is thermally stable, i.e. subsequent soldering of the holding rod to the anode or cathode does not change the properties of the MoQ.

### BRIEF DESCRIPTION OF THE DRAWINGS

The invention will be explained in more detail below with reference to a preferred exemplary embodiment. In the drawings:

FIG. 1 shows a schematic illustration of a discharge lamp having holding rods according to the invention;

FIG. 2 shows an enlarged illustration of a holding rod from FIG. 1;

FIG. 3 shows a testing arrangement for carrying out bending deformations of the holding rods from FIG. 1, and

FIG. 4 shows graphical results of the bending deformations from FIG. 3.

### PREFERRED EMBODIMENT OF THE INVENTION

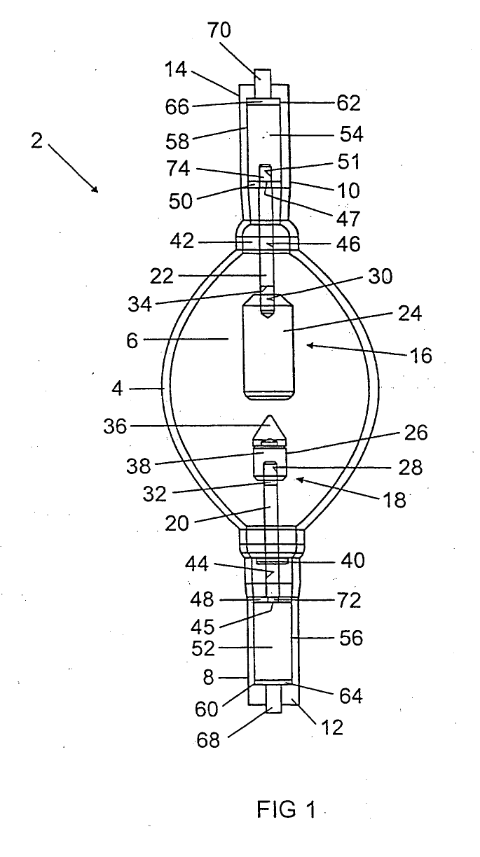

FIG. 1 shows a schematic illustration of a mercury vapor short-arc lamp (HBO) or a xenon short-arc lamp (XBO) having a base at two ends. Said lamp has a discharge vessel 4 consisting of quartz glass and having an interior 6 and two diametrically arranged, sealed bulb shafts 8, 10, whose free end sections 12, 14 are each provided with a base shell (not illustrated). Two diametrically arranged electrodes 16, 18 protrude into the interior 6, and a gas discharge is formed between them during lamp operation. An ionizable filling is enclosed in the interior 6 of the discharge vessel 4, which ionizable filling essentially consists of a noble gas.

The electrodes 16, 18 are in the form of a two-part electrode system comprising a current-supplying holding rod 20, 22 and a discharge-side head electrode 24 (anode) or head electrode 26 (cathode), which is soldered to said holding rod 20, 22.

In order to fit the electrode heads 24, 26 to the holding rods 20, 22, the electrode heads 24, 26 are each provided with a blind hole 28, 30 on the side remote from the discharge, first end sections 32, 34 of the holding rods 20, 22 being fixed in said blind holes 28, 30.

As shown in FIG. 1, the anode 24 is in the form of a barrel-shaped head anode which is subjected to a high thermal load and in the case of which the output power is improved by sufficient dimensioning of the electrode size. The cathode 26 is of multi-part design with a conical head cathode 36 in order to produce high temperatures, said head cathode 36 being fixed to a cylindrical base body 38 and ensuring that it is possible to achieve a defined arc attachment and sufficient electron flow owing to thermal emission and field emission (Richardson equation).

In order to hold the electrodes 16, 18 in the discharge vessel 4, holding elements 40, 42 consisting of quartz glass are inserted into the bulb shafts 8, 10 and are provided with an axially extending through-hole 44, 46 for receiving the holding rods 20, 22.

The holding rods 20, 22 of the electrodes 16, 18 are guided into the through-holes 44, 46 such that they reach into the interior 6 and bear the electrode heads 24 and 26, respectively, there. On the base side, the holding rods 20, 22 are each extended beyond the holding elements 40, 42 and are inserted, with a second end section 72, 74, into a receiving hole 45, 47 in an annular holding plate 48, 50.

The holding plates 48, 50 are in each case adjoined by a quartz cylinder 52, 54, which is fused into the bulb shaft 8, 10 and on whose outer circumference a plurality of molybdenum foils 56, 58 are arranged which are soldered to the holding plate 48, 50, with the result that a gas-tight current bushing is formed. In this case, in order to additionally stabilize the anode 24, the holding rod 22 is guided through the holding plate 50 into a hole 51 in the quartz cylinder 54.

The molybdenum foils 56, 58 are soldered at in each case one end section 60, 62 to the edge of a contact plate 64, 66, which is connected to a pin 68, 70 for the purpose of making electrical contact with the electrodes 16, 18.

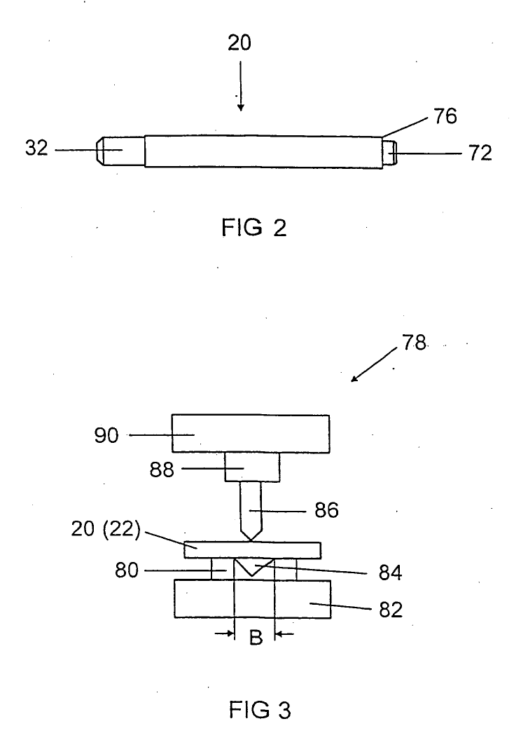

As shown in FIG. 2, the first end section 32 and the second end section 72 of the cathode-side holding rod 20 are stepped back radially in order to be received in the holes 28, 45. The holding rod 20 is fixed in the holes 28, 45 in each case by means of soldering at approximately 1800° C.

The first end section 32 is stepped back to a lesser extent in the radial direction than the second end section 72. The first end section 32, as shown in the illustration in FIG. 1, is longer in the axial direction than the depth of the blind hole 28, it being possible for the axial length, for example for reasons of stability, to also be selected such that the holding rod 20 touches the cathode 26 with a corresponding annular front face. In order to insert the first holding rod 20 easily into the blind hole 28, the first end section 32 is beveled.

The second end section 72 is stepped back such that an annular front face 76 is formed, via which the holding rod 20 touches the holding plate 48 areally. In this case, the axial length of the second end section 72 is selected such that the holding rod 20 does not pass through the holding plate 48.

The anode-side holding rod 22 (not illustrated in detail) has a similar design to the cathode-side holding rod 20 described in FIG. 2. The difference consists in the fact that the second end section 74 of the holding rod 22 is extended beyond the holding plate 50 in order to dip into the hole 51 in the quartz cylinder 54. The extension has the advantage that the anode mass is likewise accommodated by the quartz cylinder 54, and the discharge lamp 2 therefore has a more stable design.

According to the invention, the holding rods 20, 22 consist of molybdenum doped with potassium (MoQ), the volume content of the potassium being approximately 100 ppm to approximately 400 ppm, preferably approximately 280 ppm or approximately 300 ppm. The anode 24 and the cathode 26 primarily consist of tungsten doped with potassium (W-BSD) and the holding plates 48, 50 primarily consist of MoQ.

MoQ has a similar behavior to W-BSD in the non-recrystallized state. In this state, both materials have a very high strength and relatively good ductility. In the non-recrystallized state, W-BSD has an even higher bending strength Rm and a higher flexural yield point Rp than MoQ. In the crystallized state, however, W-BSD is very brittle, which is further intensified by the soldering at approximately 1800° C.

In contrast to this, MoQ has a very ductile structure after recrystallization annealing above 2000° C. and subsequent soldering at approximately 1800° C. This recrystallization annealing leads to a low loss in strength, but this recrystallized structure is thermally stable, with the result that the soldering of the holding rods 20, 22 to the electrodes 24, 26 and to the holding plates 48, 50 does not change the ductile properties of the MoQ.

Damage to the holding rods during transportation occurs in the case of conventional discharge lamps essentially directly in the holding rods and not in the region of the soldering of the electrodes 24, 26 or the holding plates 48, 50 and not in the region in which the bulb shafts 8, 10 are fused around the holding plates 48, 50. In order to determine the strength of the holding rods 20, 22 according to the invention as compared with known holdings rods consisting of W-BSD, bending deformation tests have been carried out. A corresponding test arrangement is illustrated in FIG. 3.

The test arrangement comprises a known universal testing machine 78 having a bearing body 80, which is arranged on a cross head 82. The holding rods 20, 22 are positioned individually so as to lie over a prism-shaped cutout 84 in the bearing body 80 and are pressed against a stationary plunger 86 by the cross head 82 being displaced, said plunger 86 being connected to a load cell 88 in a load frame 90 for the purpose of measuring the load on the respective holding rod 20, 22. The diameter of the holding rods 20, 22, in accordance with conventional holding rod geometries, is 8 mm, and the width B of the cutout 84 amounts to 10 mm. The maximum displacement speed of the cross head 82 is 1000 mm/min.

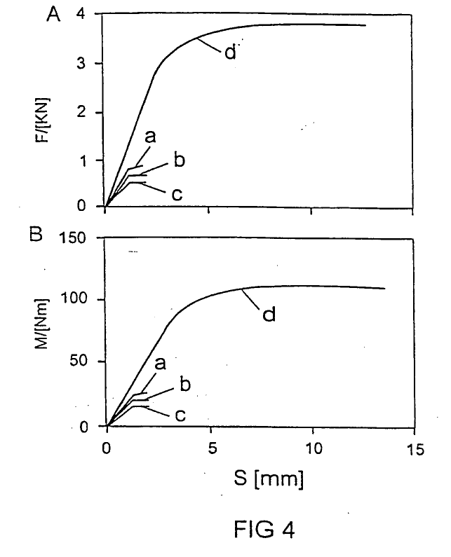

The results of the bending deformations are shown in the upper graph A and the lower graph B in FIG. 4, in graph A the bending force F in kN being plotted over the bending distance S in mm, and in graph B the bending moment M in Nm being plotted over the bending distance S in mm. A known holding rod consisting of W-BSD is deformed elastically with cracks occurring at the same time owing to breakage. Before the theoretical bending strength Rm is arrived at, a brittle fracture occurs without any plastic deformation. The broken sample halves can be joined together at the breakage point such that the sample appears to be undeformed. The maximum bending strength Rm, with an annealing treatment at 1800° C., is at a value of 581 N (graph A, curves b and c), which corresponds to a bending moment (=load*free lever arm) of 16 Nm (graph B, curves b and c). At lower annealing temperatures, for example at 1500° C., the bending strength at Rm=888 N or 26 Nm is slightly higher (curves a).

On the other hand, holding rods 20, 22 consisting of MoQ according to the invention are deformed, in accordance with the upper and lower graphs, considerably beyond the flexural yield point Rp before the breakage sets in in the material (curves d). In this case, the deformation is so severe that it is barely possible to rejoin the samples and a residual bend of approximately 3-5 mm is visible. In accordance with the upper graph, an MoQ holding rod 20, 22, which has been pre-annealed or recrystallized at 2400° C. with a holding time of 5 minutes, at 8 mm withstands a bending load of approximately 2632 N (graph A, curve d). This corresponds to a moment of 76 Nm (graph B, curve d). Only at a load of approximately 3500 N would the holding rod 20, 22 break. The shear strength (flexural yield point) is therefore approximately four times as great as the strength of known holding rods consisting of W-BSD.

Similar results as in the case of holding rods 20, 22 consisting of MoQ can be achieved with holding rods 20, 22 consisting of tungsten doped with metal oxide compounds. Advantageous metal oxide compounds are in this case lanthanum oxide, yttrium oxide and rhenium oxide.

The invention discloses a holding rod 20, 22 for a discharge lamp 2, in particular a mercury vapor or xenon short-arc lamp, for holding an anode 24 or cathode 26 in an interior 6 of a discharge vessel 4, the holding rod 20, 22 containing doped molybdenum or tungsten doped with at least one metal oxide compound. Furthermore, the invention discloses a discharge lamp having such a holding rod 20, 22.

1. A holding rod for a discharge lamp (2), in particular a mercury vapor or xenon short-arc lamp, for holding an anode (24) or cathode (26) in an interior (6) of a discharge vessel (4), characterized in that the holding rod (20, 22) contains doped molybdenum.

2. The holding rod as claimed in claim 1, the holding rod (20, 22) containing potassium as the dopant.

3. The holding rod as claimed in claim 2, the volume content of potassium being approximately 100 ppm to approximately 400 ppm, preferably approximately 280 ppm.

4. The holding rod as claimed in claim 1, the holding rod (20, 22) being annealed above 1800° C., preferably at 2400° C.

5. A holding rod for a discharge lamp (2), in particular a mercury vapor or xenon short-arc lamp, for holding an anode (24) or cathode (26) in an interior (6), characterized in that the holding rod (20, 22) contains tungsten doped with at least one metal oxide compound.

6. The holding rod as claimed in claim 5, the metal oxide compound being lanthanum oxide.

7. The holding rod as claimed in claim 5, the metal oxide compound being yttrium oxide.

8. The holding rod as claimed in claim 5, the metal oxide compound being rhenium oxide.

9. A discharge lamp having at least one holding rod (20, 22) as claimed in claim 1.

10. The holding rod as claimed in claim 2, the holding rod (20, 22) being annealed above 1800° C., preferably at 2400° C.

11. The holding rod as claimed in claim 3, the holding rod (20, 22) being annealed above 1800° C., preferably at 2400° C.
